(19) United States
(12) Patent Application Publication
(10) Pub. No.: US 2011/0278351 A1
(43) Pub. Date: Nov. 17, 2011

(54) MAGNETIC PARTICLE ATTACHMENT MATERIAL

(76) Inventors: Aleksandar Aleksov, Chandler, AZ (US); Rajasekaran Swaminathan, Chandler, AZ (US); Nachiket Raravikar, Gilbert, AZ (US)

(21) Appl. No.: 12/777,476

(22) Filed: May 11, 2010

(51) Int. Cl. B23K 31/02; B23K 1/20

(52) U.S. Cl. 228/234.1

(57) ABSTRACT

The present disclosure relates to the field of fabricating microelectronic packages, wherein a magnetic particle attachment material comprising magnetic particles distributed within a carrier material may be used to achieve attachment between microelectronic components. The magnetic particle attachment material may be exposed to a magnetic field, which, through the vibration of the magnetic particles within the magnetic particle attachment material, can heat a solder material to a reflow temperature for attaching microelectronic components of the microelectronic packages.

### BACKGROUND

A typical microelectronic package includes at least one microelectronic die that is mounted on a substrate such that bond pads on the microelectronic die are attached directly to corresponding bond lands on the substrate using reflowable solder materials.

### BRIEF DESCRIPTION OF THE DRAWINGS

The subject matter of the present disclosure is particularly pointed out and distinctly claimed in the concluding portion of the specification. The foregoing and other features of the present disclosure will become more fully apparent from the following description and appended claims, taken in conjunction with the accompanying drawings. It is understood that the accompanying drawings depict only several embodiments in accordance with the present disclosure and are, therefore, not to be considered limiting of its scope. The disclosure will be described with additional specificity and detail through use of the accompanying drawings, such that the advantages of the present disclosure can be more readily ascertained, in which:

FIGS. 1-5 illustrate side cross-sectional views of a process of attaching a microelectronic device to a microelectronic substrate using a magnetic particle attachment material;

FIGS. 6 and 7 illustrate side cross-sectional views of another process of attaching a microelectronic device to a microelectronic substrate using a magnetic particle attachment material;

FIGS. 8 and 9 illustrate side cross-sectional views of yet another process of attaching a microelectronic device to a microelectronic substrate using a magnetic particle attachment material;

FIGS. 10-12 illustrate side cross-sectional views of mechanisms for placing the magnetic particle attachment material on solder interconnect bumps of the microelectronic substrate;

FIG. 13 illustrates a side cross-sectional view of the attachment of the microelectronic device to the microelectronic substrate using any of the mechanisms of FIGS. 10-12;

FIGS. 14-17 illustrate side cross-sectional views of a process of attaching the microelectronic device to a microelectronic substrate by placing the magnetic particle attachment material on attachment projections of the microelectronic device;

FIGS. 18 and 19 illustrate side cross-sectional views of a process of attaching the microelectronic device to a microelectronic substrate by placing the magnetic particle attachment material on the solder interconnect bumps of the substrate by immersing the solder interconnect bumps in the magnetic particle attachment material;

FIGS. 20 and 21 illustrate side cross-sectional views of still another process of attaching a microelectronic device to a microelectronic substrate using a magnetic particle attachment material;

FIGS. 22-24 illustrate side cross-section views of a process for attaching a heat spreader to a back surface of a microelectronic device using a magnetic particle attachment material;

FIGS. 25-27 illustrate side cross-section views of a process of attaching a first microelectronic device attachment structure to a second microelectronic device solder material using a magnetic particle attachment material; and

FIG. 28 is a flow diagram of a process of attaching a first component attachment structure to a second component solder material using a magnetic particle attachment material.

### DETAILED DESCRIPTION

In the following detailed description, reference is made to the accompanying drawings that show, by way of illustration, specific embodiments in which the claimed subject matter may be practiced. These embodiments are described in sufficient detail to enable those skilled in the art to practice the subject matter. It is to be understood that the various embodiments, although different, are not necessarily mutually exclusive. For example, a particular feature, structure, or characteristic described herein, in connection with one embodiment, may be implemented within other embodiments without departing from the spirit and scope of the claimed subject matter. In addition, it is to be understood that the location or arrangement of individual elements within each disclosed embodiment may be modified without departing from the spirit and scope of the claimed subject matter. The following detailed description is, therefore, not to be taken in a limiting sense, and the scope of the subject matter is defined only by the appended claims, appropriately interpreted, along with the full range of equivalents to which the appended claims are entitled. In the drawings, like numerals refer to the same or similar elements or functionality throughout the several views, and that elements depicted therein are not necessarily to scale with one another, rather individual elements may be enlarged or reduced in order to more easily comprehend the elements in the context of the present description.

Embodiments of the present description relate to the field of fabricating microelectronic packages, wherein a magnetic particle attachment material comprising magnetic particles distributed within a carrier material may be used to achieve attachment between microelectronic components. The magnetic particle attachment material may be exposed to a magnetic field, which, through the vibration of the magnetic particles within the magnetic particle attachment material, can heat a solder material to a reflow temperature for attaching microelectronic components of the microelectronic package.

In the production of microelectronic packages, microelectronic dice are generally mounted on substrates that may, in turn, be mounted to boards, which provide electrical communication routes between the microelectronic dice and external components. A microelectronic die, such as a microprocessor, a chipset, a graphics device, a wireless device, a memory device, an application specific integrated circuit, or the like, may be attached to a substrate, such as an interposer, a motherboard, and the like, through a plurality of interconnects, such as reflowable solder bumps or balls, in a configuration generally known as a flip-chip or controlled collapse chip connection (“C4”) configuration. When the microelectronic die is attached to the substrate with interconnects made of solder, the solder is reflowed (i.e. heated) to secure the solder between the microelectronic die bond pads and the substrate bond pads.

During such an attachment, a thermal expansion mismatch may occur between the microelectronic die and the substrate as the solder is heated to a reflow temperature and subsequently cooled after the attachment. This thermal expansion mismatch can warp the microelectronic package, as well as result in significant yield losses and failures due to, for example, stretched joint formation, solder bump cracking, under bump metallization failures, edge failures, and layer separation within the substrates and microelectronic dice, as will be understood to those skilled in the art.

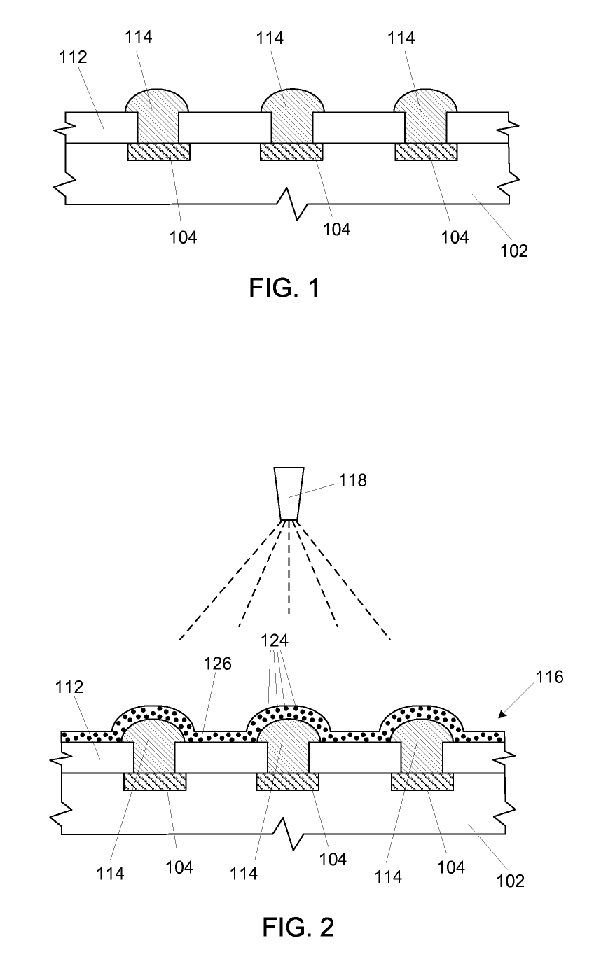

FIGS. 1-8 illustrate an embodiment of using a magnetic particle attachment material to locally heat interconnects according to one embodiment of the present disclosure. FIG. 1 shows a microelectronic component, such a substrate 102, having at least one attachment structure, such as bond pads 104, formed therein. The substrate 102 may be primarily composed of any appropriate material, including, but not limited to, bismaleimine triazine resin, fire retardant grade 4 material, polyimide materials, glass reinforced epoxy matrix material, and the like, as well as laminates or multiple layers thereof. The substrate bond pads 104 may be composed of any conductive metal, including but not limited to, copper, aluminum, nickel, silver, and alloys thereof. The substrate bond pads 104 may be in electrical communication with conductive traces (not shown) within the substrate 102.

An outer dielectric layer 112 may be formed adjacent the substrate 102 and the substrate bond pads 104. The outer dielectric layer 112 may be a solder resist material, including but not limited to epoxy and epoxy-acrylate resins. The substrate 102, substrate bond pad 104, and the outer dielectric layer 112 may be formed by any known techniques, as will be understood by those skilled in the art.

At least one solder interconnect bump 114 can be formed through an opening in the outer dielectric material 112, by any known techniques, including but not limited to printing. The solder interconnect bumps 114 may be any appropriate material, including but not limited to lead/tin alloys, such as tin/lead solder, such as 63% tin/37% lead solder, or lead-free solders, such a pure tin or high tin content alloys (e.g. 90% or more tin), such as tin/bismuth, eutectic tin/silver, ternary tin/silver/copper, eutectic tin/copper, and similar alloys.

A magnetic particle attachment material 116 may be deposited adjacent to the solder interconnect bumps 114. As shown in FIG. 2, the magnetic particle attachment material 116 may be deposited with a spray dispersion device 118. In one embodiment, the magnetic particle attachment material 116 is deposited over the bump field area, which may be defined as the area encompassing the solder interconnect bumps 114 and the outer dielectric layer 112 between and proximate to the solder interconnect bumps 114.

The magnetic particle attachment material 116 may comprise magnetic particles 124 dispersed in a carrier material 126. The carrier material 126 may be an appropriate material, including but not limited to solvents, such as poly-ethylene glycol, and/or water, in combination with a surfactant, such as oleic acid. In one embodiment, the carrier material 126 may contain at least one flux material which may include, but is not limited to, ammonium chloride, rosin, organic acids and/or amines, and inorganic acids and/or amines. Flux materials may improve electrical connection and may improve mechanical strength of subsequent interconnect formation (as will be discussed) by chemically removing oxides and residue on the solder interconnect bumps 114. It is understood that the magnetic particles 124 may be treated with silane coupling agents and/or thiol groups for effective dispersion within the flux material. It is also understood that, depending on the selection of interconnect bump 114 material, such flux-type materials may not be necessary, and inert carriers may be used.

The magnetic particles 124 may include, but are not limited to, iron (Fe), cobalt (Co), nickel (Ni), and their respective alloys. Examples may also include ferrites and oxides containing magnetic metals. In one embodiment, the magnetic particles may be MFe₂O₄, where M may be any metal and O is oxygen. In another embodiment, the magnetic particles may be BaFe₁₂O₁₇, where Ba is barium. In yet another embodiment, the magnetic particles may comprise an iron/cobalt alloy. In certain embodiments, the magnetic particles may include a coating such as a conformal tin (Sn)/tin-based alloy/copper (Cu) layer formed, for example, by a deposition procedure, such as sputtering.

In one embodiment, the magnetic particle attachment material 116 may contain between about 1% and 99% by weight of magnetic particles 124. In a more specific embodiment, the magnetic particle attachment material 116 may contain between about 1% and 10% by weight of magnetic particles 124. In another embodiment, the magnetic particle attachment material 116 may have magnetic particles 124 sized between about 5 nm and 100 nm in length. In general, the content of magnetic particles 124 within the carrier material 126 should be sufficiently high enough to allow for efficient heating (as will be discussed), but sufficiently low enough to allow for uniform dispensation. This will, of course, depend on the size and type of magnetic particles 124 used, the characteristics of the carrier material 126, such as the viscosity, and the method of applying the magnetic particle attachment material 116.

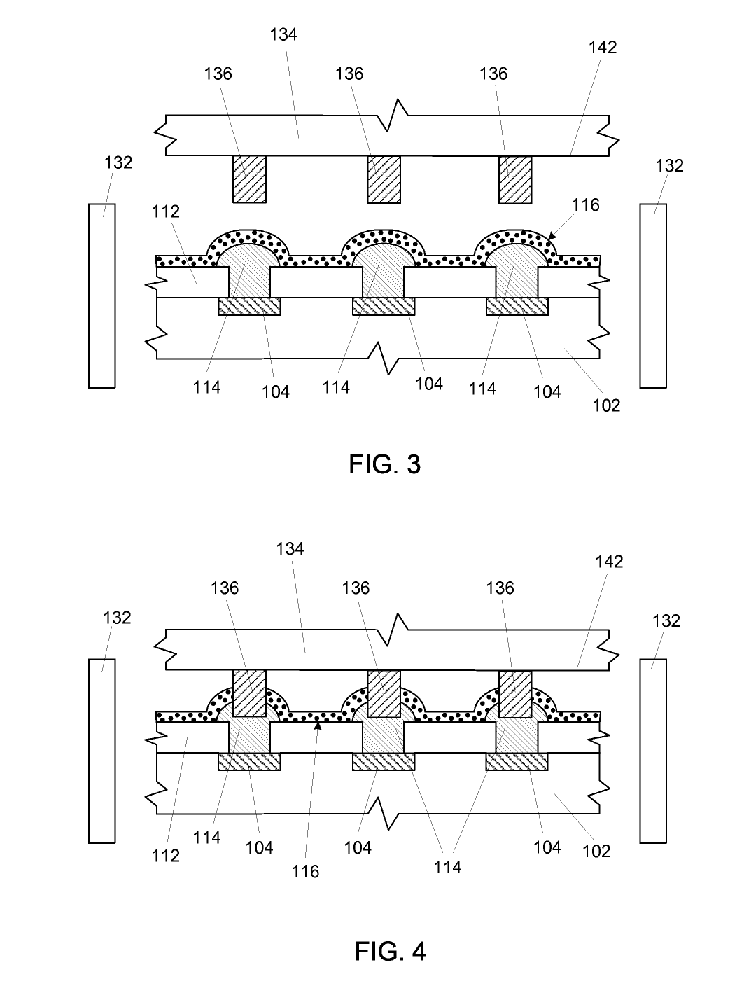

The magnetic particle attachment material 116 may be used to attach microelectronic devices or components to one another. As shown in FIG. 3, a microelectronic component, such as a microelectronic device 134 including a microelectronic die or an interposer, may be provided with at least one attachment structure, such as at least one attachment projection 136 (shown) or at least one bond pad, on a first surface 142 thereof. The microelectronic device attachment projections 136 may be any appropriate metal material, including but not limited to copper and alloys thereof. A pattern or distribution of the microelectronic device attachment projections 136 may be a substantial mirror-image to the pattern or distribution of the substrate interconnect bumps 114.

A magnetic field generator 132, as also shown in FIG. 3, may be placed proximate the substrate 102. In the presence of alternating current magnetic fields generated by the magnetic field generator 132, the magnetic particles 124 (see FIG. 2) within the magnetic particle attachment material 116 will generate heat by relaxational and hysteretic loss modes. Relaxational losses occur in single domain magnetic particles and they release heat when the magnetic moment of the particle rotates with the applied magnetic field (Neel motion) and when the particle itself rotates due to Brownian motion. Hystereis losses occur in multi-domain particles, and generate heat due to the various magnetic moments (due to multi-domains) rotating against the applied magnetic field. These losses occur with every cycle in the alternating current field, and the net heat generated increases with increasing number of field cycles. The various factors controlling heating rates may include, but are not necessarily limited to, magnetic particle size and size distribution, magnetic particle volume fractions (heat generation scales substantially linearly with volume fraction), magnetic material choice (oxides, metallic (pure and alloy), and layered magnetic particles (as previously discussed)), shape anisotropy of the magnetic particles, and the applied frequency and amplitude of the alternating current used in the magnetic field generator 132. Therefore, when an alternating current magnetic field is applied by the magnetic field generator 132, the magnetic particles 124 (see FIG. 2) within the magnetic particle attachment material 116 essentially vibrate and heat up to at least the reflow temperature of the solder interconnect bump 114.

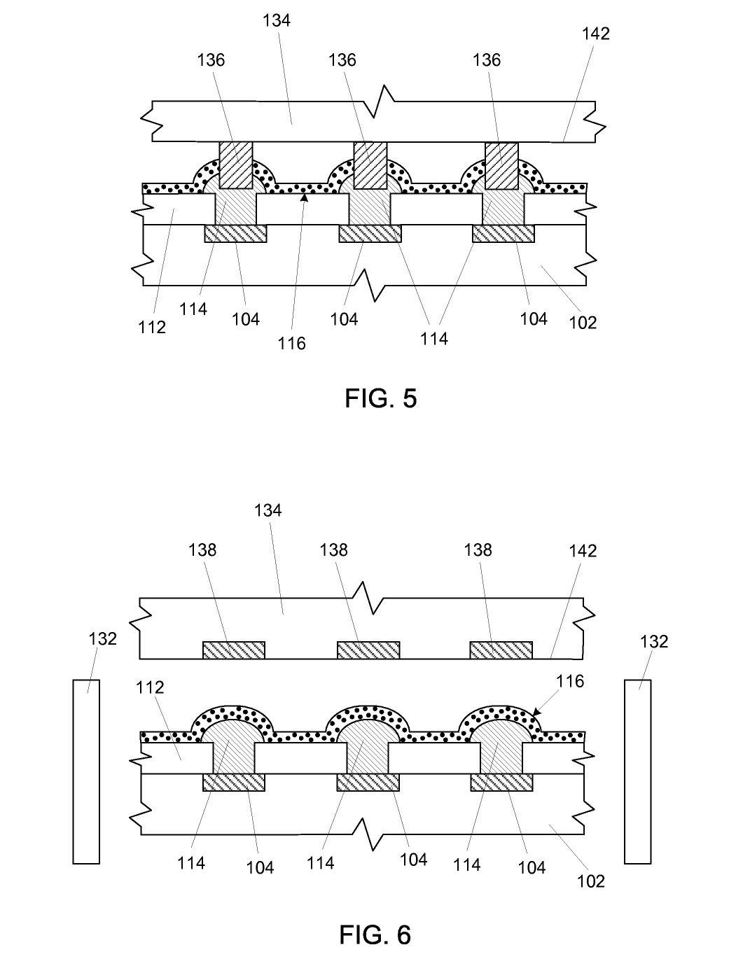

As shown in FIG. 4, the microelectronic device attachment projections 136 may be brought into contact with their respective reflowed solder interconnect bumps 114. The magnetic field generator 132 may then be deactivated, or the substrate and the attached microelectronic device 134 may be removed from the magnetic field, which allows the solder interconnect bumps 114 to cool and re-solidify to form an interconnection between the solder interconnect bumps 114 and microelectronic device attachment projections 136, as shown in FIG. 5. It is understood that any residual magnetic particle attachment material 116, in this or any other described embodiment, may be removed with known removal process, such as defluxing.

Since heating the solder interconnect bumps 114 to a reflow temperature during attachment to the microelectronic device 134 is localized proximate the magnetic particle attachment material 116, other components (layer, traces, and the like) in the substrate are only minimally heated up relative to external heating techniques. Thus, the magnetic heating of the present disclosure may minimize stresses due to thermal expansion mismatch.

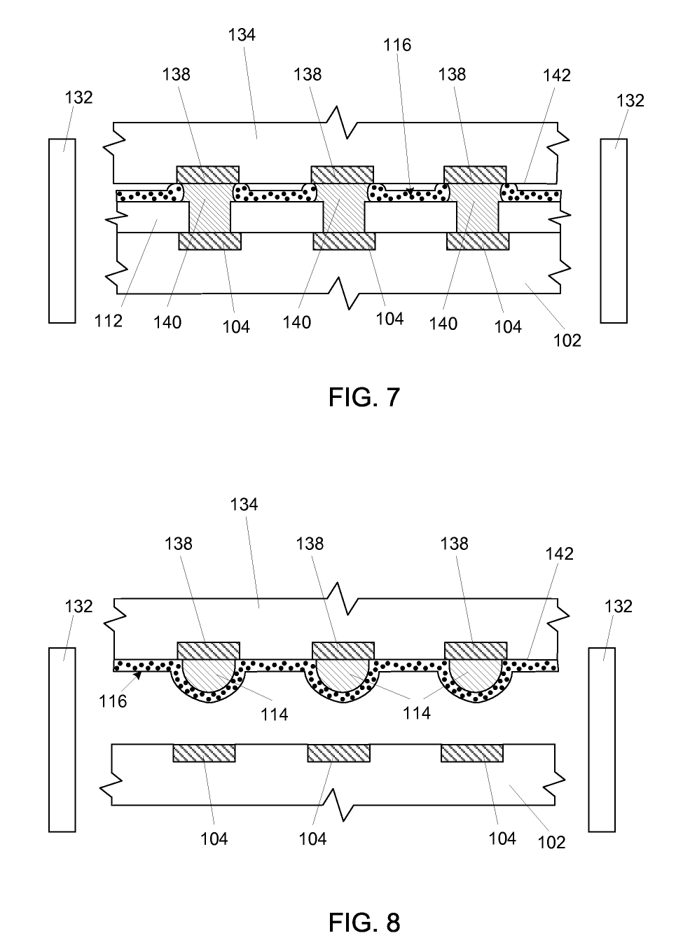

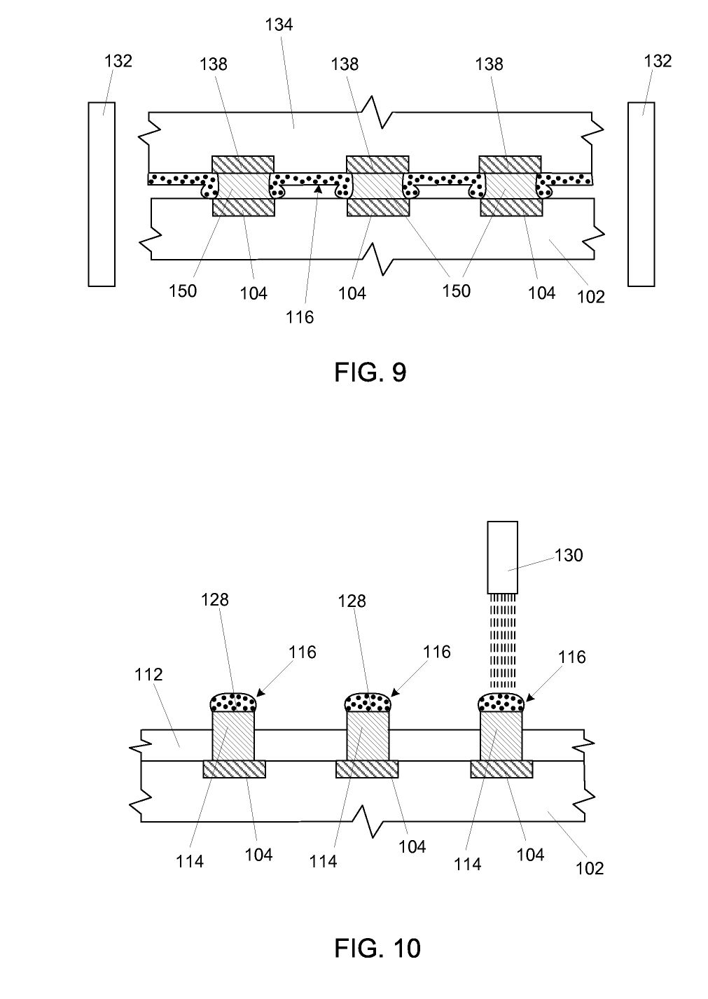

It is understood that the microelectronic device attachment structure is not limited to microelectronic device attachment projections 136, as shown but may be other attachments structures, such as contact lands 138 (either recessed, flush, or projected), as shown in FIG. 6. The contact lands may be copper, aluminum, nickel, silver, and alloys thereof, and may be in electric communication with integrated circuits (not shown) within the microelectronic device 134. As shown in FIG. 7, the attachment of the solder interconnect bumps 114 to the contact lands 138 may be achieved in the manner described with regard to FIGS. 2-5 to form interconnects 140. Further, as shown in FIG. 8, it is understood that the solder interconnect bumps 114 may be applied to the contact lands 138 rather than the substrate bond pads 104 (as shown in FIG. 2-7) with the magnetic particle attachment material 116 applied thereto. As shown in FIG. 9, the attachment of the solder interconnect bumps 114 to the substrate bond pads 104 may be achieved in the manner described with regard to FIGS. 2-5 to form interconnects 150. These concepts can be applied to any of the embodiments described herein.

Although the described embodiments within this description are directed to the substrate 102 and the microelectronic device 134, it is understood that the concepts apply equally to any microelectronic packaging process, including but not limited to First Level Interconnects (FLI) where microelectronic dice are attached to substrates or interposers, to Second Level Interconnects (SLI) where substrates or interposers are attached to a board or a motherboard, and to Direct Chip Attach (DCA) where microelectronic dice are attached directly to a board or a motherboard.

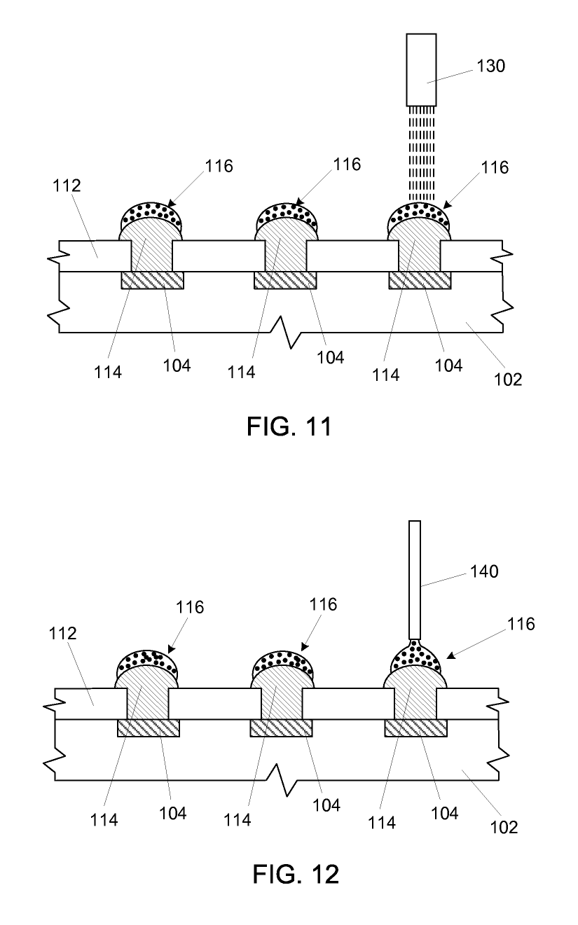

Another embodiment of the subject matter of the present description is shown in FIGS. 10-13, wherein the magnetic particle attachment material 116 is formed substantially only on the solder interconnect bumps 114. As shown in FIG. 10, the magnetic particle attachment material 116 may be sprayed directly on the solder interconnect bump 114 substantially without contacting the outer dielectric layer 112, such as by a microsprayer 130 similar to those used in inkjet technologies. In the fabrication of solder interconnect bumps 114, the solder material is formed as a pillar, as illustrated, such by a plating technique, as will be understood to those skilled in the art. With such a plating technique, an attachment surface 128 of the solder interconnect bump 114 will be formed that is substantially flat relative to the substrate 102. The flat attachment surface 128 may assist in retaining the magnetic particle attachment material 116 on the solder interconnect bump 114. Of course, it is understood that depending on the viscosity of the magnetic particle attachment material 116 may be sprayed directly on a domed solder interconnect bump 114 and still be retained thereon, as shown in FIG. 11. As will be understood to those skilled in the art, numerous techniques could be used to place the magnetic particle attachment material 116 on the solder interconnect bump 114, such as dispensation with a needle 140, as shown in FIG. 12, by “painting” the magnetic particle attachment material 116 on the solder interconnect bump 114 with a “brush”-type device (not shown), or by screen printing techniques (not shown).

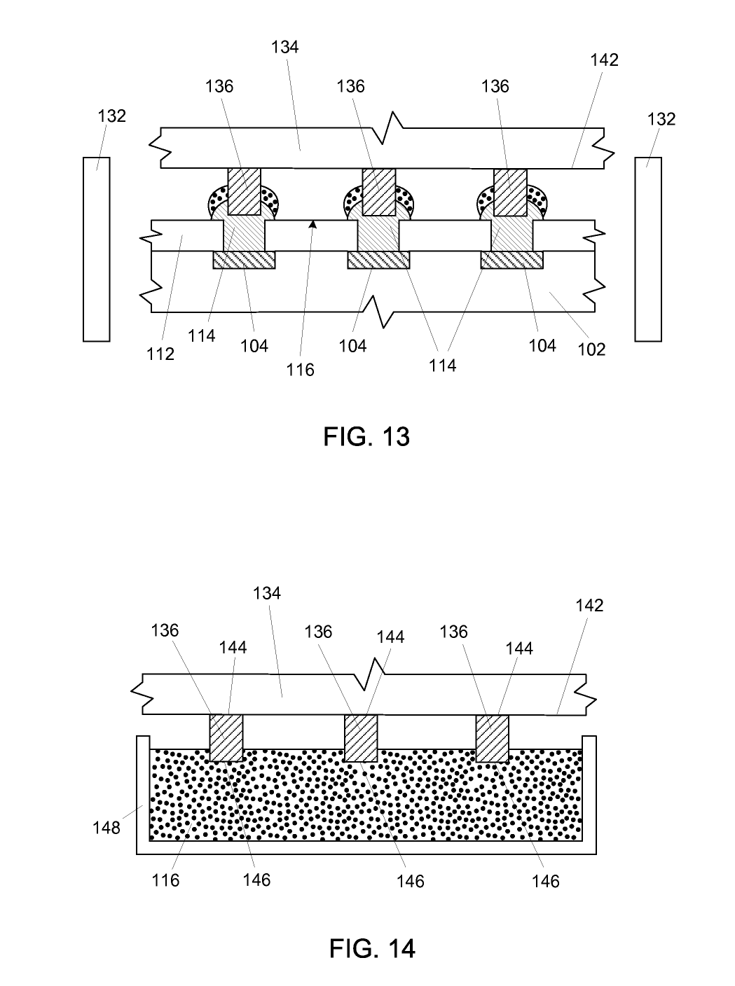

Once the magnetic particle attachment material 116 is deposited on the solder interconnect bumps 114, the magnetic field generator 132 may be placed proximate the substrate 102, as shown in FIG. 13. An alternating current magnetic field may then be applied by the magnetic field generator 132, so that the magnetic particles 124 (see FIG. 2) within the magnetic particle attachment material 116 vibrate and heat up to at least the reflow temperature of the solder interconnect bumps 114. As also shown in FIG. 13, the microelectronic device attachment projections 136 may be brought into contact with their respective reflowed solder interconnect bumps 114. The magnetic field generator 132 may then be deactivated, or the substrate 102 and the attached microelectronic device 134 may be removed from the magnetic field, which allows the solder interconnect bumps 114 to cool and re-solidify to form an interconnection between the solder interconnect bumps 114 and microelectronic device attachment projections 136. By only having the magnetic particle attachment material 116 proximate the solder interconnect bumps 114, the heating is more localized to the solder interconnect bumps 114, than with the embodiment shown in FIGS. 2-5.

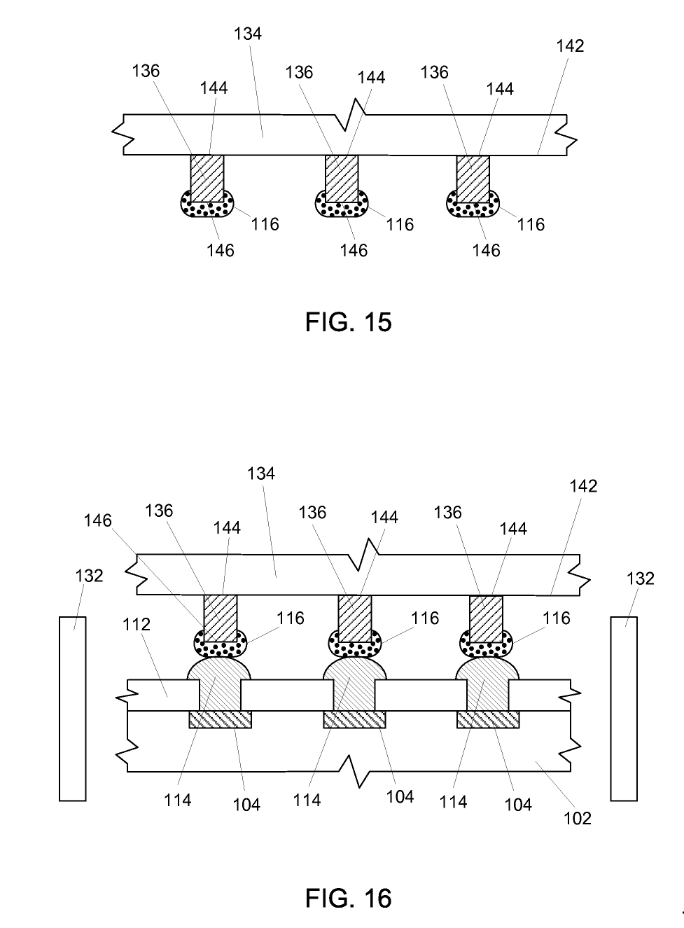

The magnetic particle attachment material 116 may also be placed on the microelectronic device attachment projections 136, rather than being placed on the solder interconnect bumps 114. As shown in FIG. 14, the microelectronic device attachment projections 136 may have a device end 144 attached to the microelectronic device 134 proximate the microelectronic device first surface 142 and an opposing contact end 146. A reservoir 148 containing the magnetic particle attachment material 116 may be provided and the microelectronic device attachment projection contact ends 146 may be immersed in the magnetic particle attachment material 116, as further shown in FIG. 14. When the microelectronic device attachment projection contact ends 146 are removed from the magnetic particle attachment material 116 in the reservoir 148, a portion of the magnetic particle attachment material 116 remains on each of the microelectronic device attachment projection contact ends 146, as shown in FIG. 15.

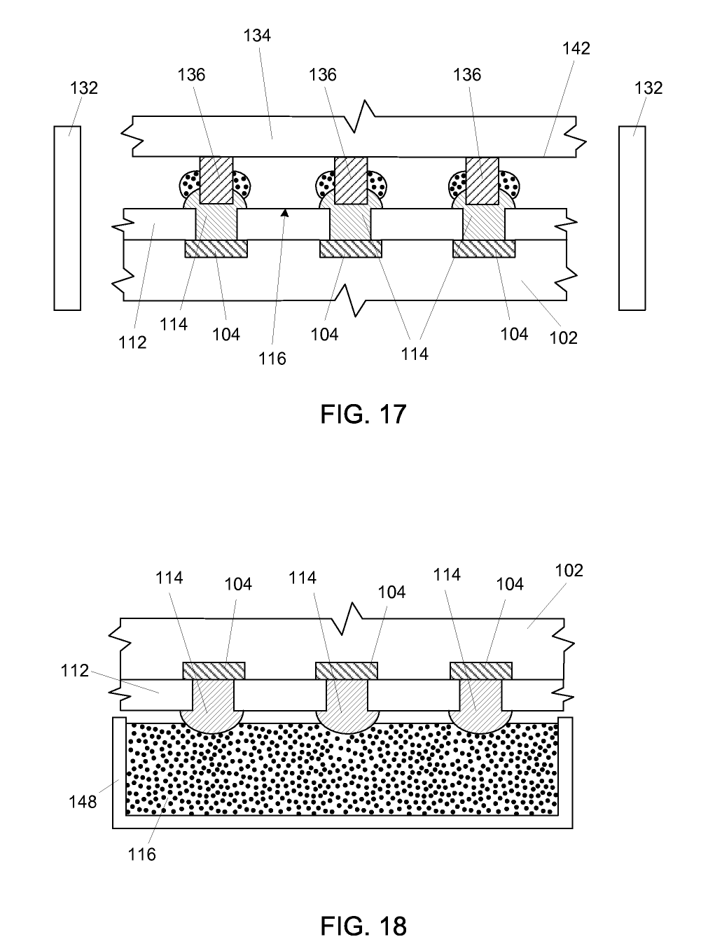

As shown in FIG. 16, the magnetic particle attachment material 116 on each of the microelectronic device attachment projection contact ends 146 may be brought into contact with their respective solder interconnect bumps 114 and a magnetic field generator 132 may be placed proximate the substrate 102. An alternating current magnetic field may then be applied by the magnetic field generator 132 and the magnetic particles 124 (see FIG. 2) within the magnetic particle attachment material 116 vibrate and heat up to at least the reflow temperature of the solder interconnect bumps 114. As shown in FIG. 17, the microelectronic device attachment projections 136 may then be brought into contact with their respective reflowed solder interconnect bumps 114. The magnetic field generator 132 may then be deactivated, or the substrate and the attached microelectronic die 134 may be removed from the magnetic field, which allows the solder interconnect bumps 114 to cool and re-solidify to form an interconnection between the solder interconnect bumps 114 and microelectronic device attachment projections 136.

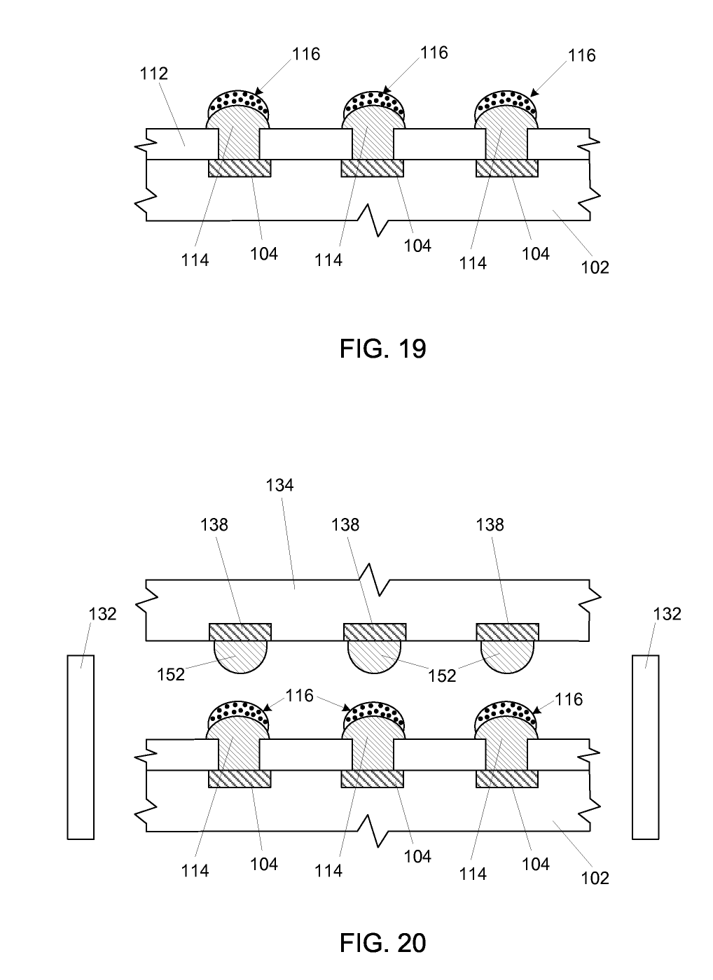

In another embodiment, the solder interconnect bumps may be immersed in the magnetic particle attachment material 116 within the reservoir 148, as shown in FIG. 18, such that magnetic particle attachment material 116 is deposited thereon, as shown in FIG. 19, and previously described attachment processes may be followed.

Although the illustrated embodiments show that magnetic particle attachment material 116 is applied to either the solder interconnect bumps 114 or the microelectronic device attachment projections 136, it is understood that the magnetic particle attachment material 116 could be applied to both.

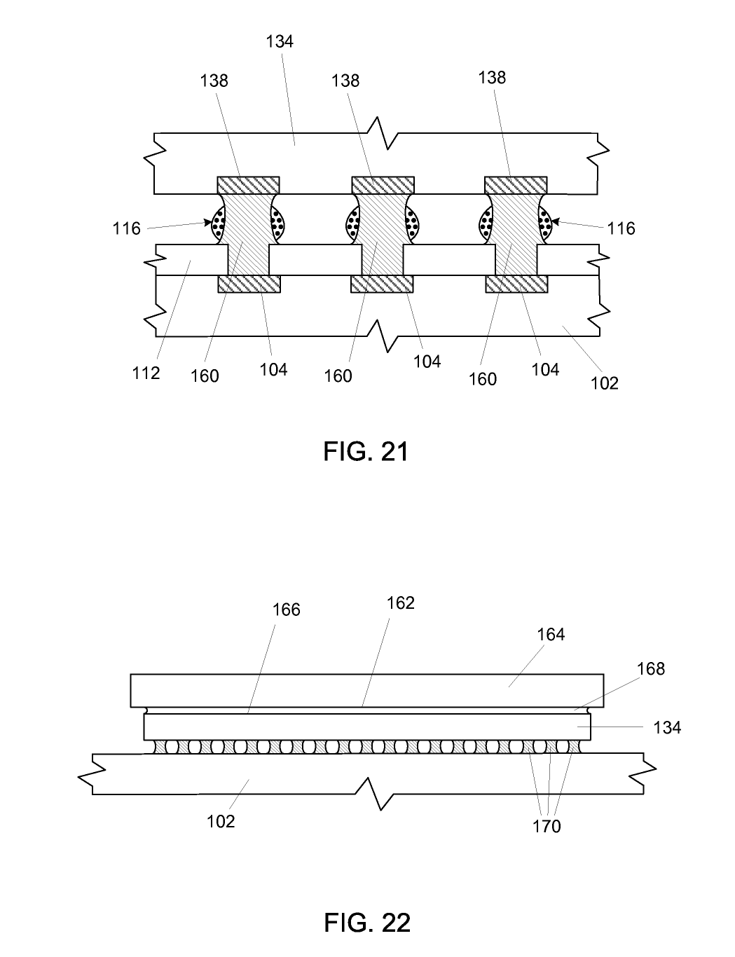

Furthermore, it is understood that the magnetic particle attachment material 116 could be used to attach a solder material of a first component to a solder attachment structure of a second component. In one embodiment, as shown in FIG. 20, the substrate 102, as shown and described in FIG. 1, with magnetic particle attachment material 116 on solder interconnect bumps 114 is provided, and a microelectronic device 134 having a solder attachment structures 152 formed on the microelectronic device contact lands 138 is also provided. The magnetic field generator 132 may be placed proximate the substrate 102 and the microelectronic device 134 and an attachment process as previously described may be followed wherein both the substrate solder interconnect bumps 114 and the microelectronic device solder attachment structures 152 reflow to form solder interconnects 160, as shown in FIG. 21.

It is also understood that the subject matter of the present description is not necessarily limited to specific applications illustrated in FIGS. 1-21. The subject matter may be applied to other solder attachment processes in the fabrication of microelectronic devices, including, but not limited to, attachment of devices to a motherboard, attachment of integrated heat spreaders, and the like. Furthermore, the subject matter may also be used in any appropriate solder attachment application outside of the microelectronic device fabrication field.

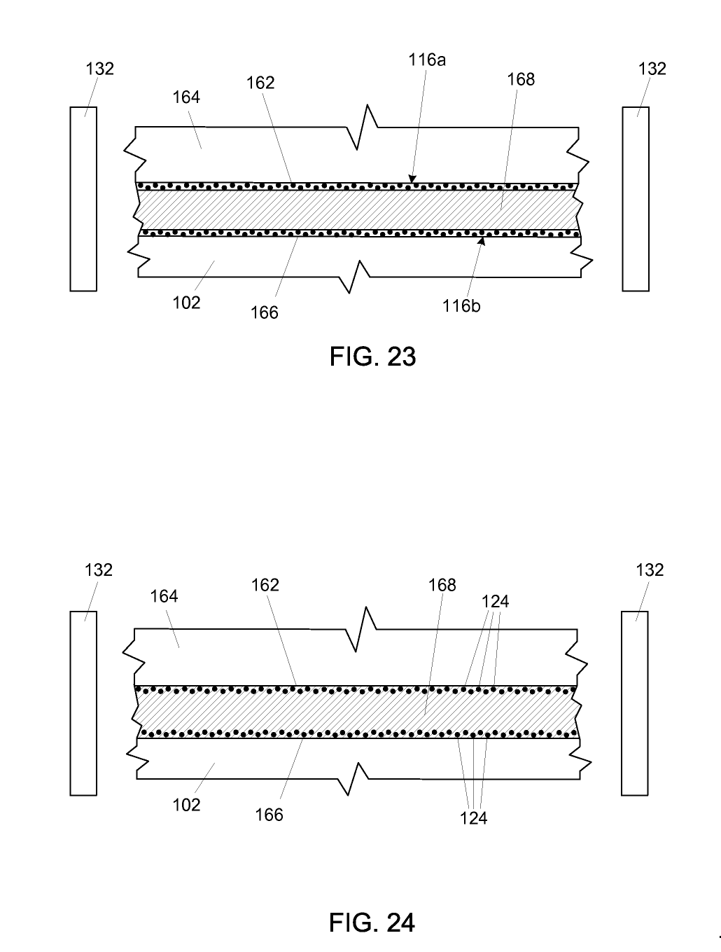

FIGS. 22-24 illustrate one such embodiment of an attachment of an attachment surface 162 of an integrated heat spreader 164 to a back surface 166 of the microelectronic die 134 with a thermal interface material 168. The microelectronic die 134 may be attached to the substrate 102 through a plurality of interconnects 170. As shown in FIG. 23, the magnetic attachment material, shown as elements 116a and 116b, may be dispersed between the thermal interface material 168 and the integrated heat spreader attachment surface 162, and between the thermal interface material 168 and the microelectronic device back surface 166. The thermal interface material 168 may be a solder material, as previously described. As shown in FIG. 24, the magnetic attachment material 116a and 116b may be heated with the magnetic field generator 132 in a manner previously described to attach the integrated heat spreader 164 to the microelectronic 134 with the thermal interface material 168. As also shown in FIG. 24, the magnetic particles 124 and the carrier material 126 (not shown) that comprise the magnetic attachment material 116a and 116b may be subsumed in the thermal interface 168.

Thus, it can be considered that the integrated heat spreader attachment surface 162 may be an attachment surface of a second component (i.e. the integrated heat spreader) and that the solder thermal interface material 168 may be a solder material of a first component (i.e. the microelectronic device 134). It can be further considered that the microelectronic device back surface 168 may be an attachment surface of a second component (i.e. the microelectronic device) and that the solder thermal interface material 168 may be a solder material of a first component (i.e. the integrated heat spreader).

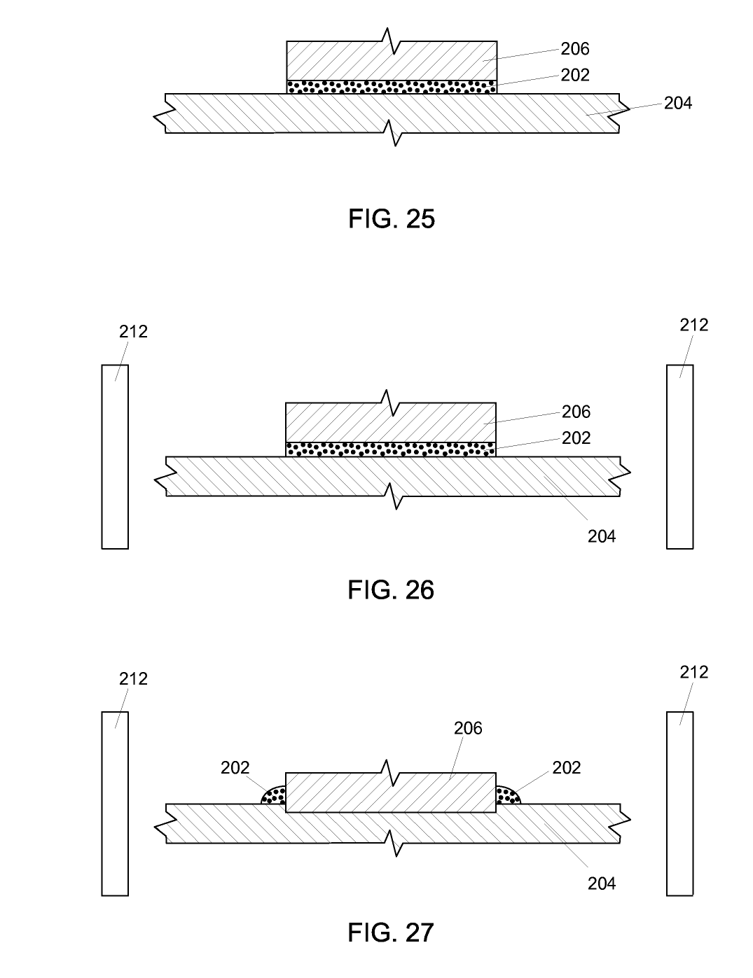

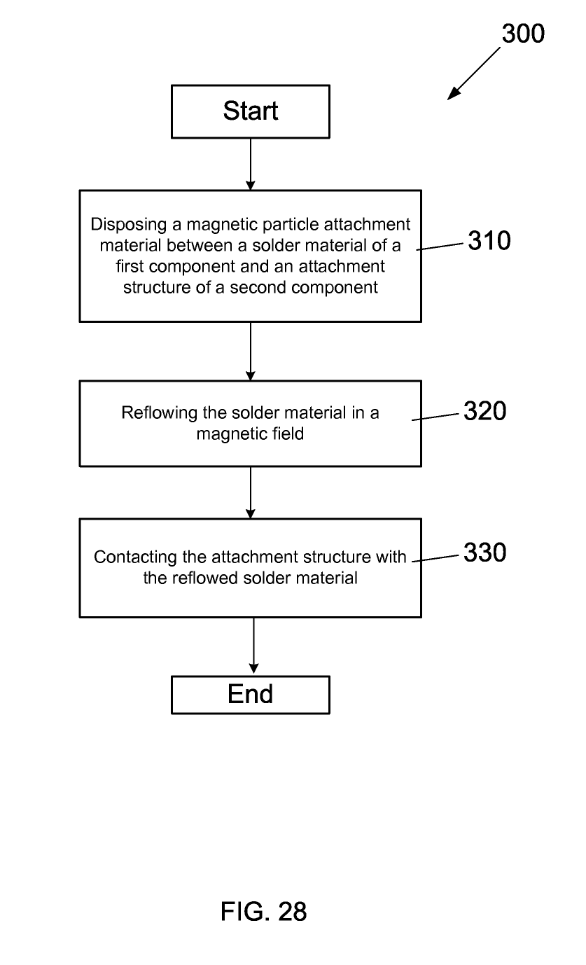

An embodiment of a process of the present description is illustrated in FIGS. 25-27 and in the flow diagram 300 of FIG. 28. As shown in FIG. 25 and defined in block 310 of FIG. 28, a magnetic particle attachment material 202, such as previously described, may be disposed between a solder material 204 of a first component (such as substrate 102 of FIGS. 1-9, 12, and 13 or the microelectronic device 134 of FIGS. 8 and 20) and an attachment structure 206 of a second component (such as the microelectronic device attachment projection 134 of FIGS. 3-5 and 9-13, the microelectronic device contact land of FIG. 6, and the microelectronic device solder attachment structure 152 of FIG. 20). The solder material 204 may be reflowed in an alternating current magnetic field that may be generated with a magnetic field generator 212 proximate the magnetic particle attachment material 202, which generates heat in the alternating current magnetic field, as shown in FIG. 17 and defined in block 320 of FIG. 19. As shown in FIG. 18 and defined in block 330 of FIG. 19, the attachment structure 206 may be brought into contact with the reflowed solder material 204.

The detailed description has described various embodiments of the devices and/or processes through the use of illustrations, block diagrams, flowcharts, and/or examples. Insofar as such illustrations, block diagrams, flowcharts, and/or examples contain one or more functions and/or operations, it will be understood by those skilled in the art that each function and/or operation within each illustration, block diagram, flowchart, and/or example can be implemented, individually and/or collectively, by a wide range of hardware, software, firmware, or virtually any combination thereof.

The described subject matter sometimes illustrates different components contained within, or connected with, different other components. It is understood that such illustrations are merely exemplary, and that many alternate structures can be implemented to achieve the same functionality. In a conceptual sense, any arrangement of components to achieve the same functionality is effectively “associated” such that the desired functionality is achieved. Thus, any two components herein combined to achieve a particular functionality can be seen as “associated with” each other such that the desired functionality is achieved, irrespective of structures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

It will be understood by those skilled in the art that terms used herein, and especially in the appended claims are generally intended as “open” terms. In general, the terms “including” or “includes” should be interpreted as “including but not limited to” or “includes but is not limited to”, respectively. Additionally, the term “having” should be interpreted as “having at least”.

The use of plural and/or singular terms within the detailed description can be translated from the plural to the singular and/or from the singular to the plural as is appropriate to the context and/or the application.

It will be further understood by those skilled in the art that if an indication of the number of elements is used in a claim, the intent for the claim to be so limited will be explicitly recited in the claim, and in the absence of such recitation no such intent is present. Additionally, if a specific number of an introduced claim recitation is explicitly recited, those skilled in the art will recognize that such recitation should typically be interpreted to mean “at least” the recited number.

The use of the terms “an embodiment,” “one embodiment,” “some embodiments,” “another embodiment,” or “other embodiments” in the specification may mean that a particular feature, structure, or characteristic described in connection with one or more embodiments may be included in at least some embodiments, but not necessarily in all embodiments. The various uses of the terms “an embodiment,” “one embodiment,” “another embodiment,” or “other embodiments” in the detailed description are not necessarily all referring to the same embodiments.

While certain exemplary techniques have been described and shown herein using various methods and systems, it should be understood by those skilled in the art that various other modifications may be made, and equivalents may be substituted, without departing from claimed subject matter or spirit thereof. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method of forming an interconnection, comprising:
disposing a magnetic particle attachment material between a solder material of a first component and an attachment structure of a second component;
reflowing the first component solder material in a magnetic field; and
contacting the second component attachment structure with the reflowed first component solder material.

2. The method of claim 1, wherein reflowing the first component solder material comprises heating the first component solder material to a reflow temperature with an alternating current magnetic field imparted on the magnetic particle attachment material.

3. The method of claim 1, wherein disposing the magnetic particle attachment material comprises disposing a magnetic particle attachment material including magnetic particles dispersed in a carrier material.

4. The method of claim 3, wherein disposing the magnetic particle attachment material including particles dispersed in the carrier comprises disposing the magnetic particle attachment material including magnetic particles including iron, cobalt, nickel, or alloys thereof dispersed in the carrier material.

5. The method of claim 3, wherein disposing the magnetic particle attachment material comprises disposing a magnetic particle attachment material including magnetic particles dispersed in a flux carrier material.

6. The method of claim 1, wherein disposing the magnetic particle attachment material between the first component solder material and the second component attachment structure comprises disposing a magnetic particle attachment material between first component solder material and a solder attachment structure of a second component.

7. The method of claim 1, wherein disposing the magnetic particle attachment material between the solder material of the first component and the attachment structure of the second component comprises disposing the magnetic particle attachment material between a solder material of a microelectronic device and an attachment surface of a heat spreader.

8. The method of claim 1, wherein disposing the magnetic particle attachment material between a solder material of a first component and an attachment structure of a second component comprises disposing the magnetic particle attachment material between a solder interface material of a heat spreader and a back surface of a microelectronic device.

9. A method of forming a microelectronic interconnection, comprising:
providing a first microelectronic component having at least one solder interconnect bump formed thereon;
providing a second microelectronic component having at least one attachment structure;
disposing a magnetic particle attachment material proximate the at least one solder interconnect bump;
reflowing the at least one solder interconnect bump in a magnetic field; and
contacting the at least one second component attachment structure with the at least one first microelectronic component reflowed solder interconnect bump.

10. The method of claim 9, wherein providing a first microelectronic component having at least one solder interconnect bump formed thereon and providing a second microelectronic component having at least one attachment structure comprises providing a substrate having at least one solder interconnect bump formed thereon and providing a microelectronic device having at least one attachment structure.

11. The method of claim 9, wherein providing a first microelectronic component having at least one solder interconnect bump formed thereon and providing a second microelectronic component having at least one attachment structure comprises providing a microelectronic device having at least one solder interconnect bump formed thereon and providing a substrate having at least one attachment structure.

12. The method of claim 9, wherein providing a second microelectronic component having at least one attachment structure comprises providing a second component having at least one solder attachment structure.

13. The method of claim 9, wherein reflowing the solder interconnect bump comprises heating the solder interconnect bump to a reflow temperature with an alternating current magnetic field imparted on the magnetic particle attachment material.

14. The method of claim 9, wherein disposing the magnetic particle attachment material comprises disposing a magnetic particle attachment material including magnetic particles dispersed in a carrier material.

15. The method of claim 14, wherein disposing the magnetic particle attachment material including particles dispersed in the carrier comprises disposing the magnetic particle attachment material including magnetic particles including iron, cobalt, nickel, or alloys thereof dispersed in the carrier material.

16. The method of claim 14, wherein depositing the magnetic particle attachment material comprises depositing a magnetic particle attachment material including magnetic particles dispersed in the flux carrier material.

17. The method of claim 9, wherein disposing a magnetic particle attachment material proximate the at least one solder interconnect bump comprises spraying the magnetic particle attachment material on the at least one solder interconnect bump.

18. The method of claim 17, wherein spraying the magnetic particle attachment material on the at least one solder interconnect bump comprises spraying the magnetic particle attachment material on the at least one solder interconnect bump and an outer dielectric material proximate the at least one solder interconnect bump.

19. The method of claim 9, wherein disposing a magnetic particle attachment material proximate the at least one solder interconnect bump comprises depositing the magnetic particle attachment material on a contact end of the at least one attachment structure and placing the magnetic particle attachment material to abut the at least one solder interconnect bump.

20. The method of claim 19, wherein depositing the magnetic particle attachment material on a contact end of the at least one attachment projection comprises immersing the attachment projection contact end in magnetic particle attachment material.
